(19) United States
(12) Patent Application Publication
(10) Pub. No.: US 2009/0210287 A1
(43) Pub. Date: Aug. 20, 2009

(54) ADVERTISEMENT SPACE ALLOCATION

(75) Inventors: David M. Chickering, Bellevue, WA (US); Yagil Engel, Bellevue, WA (US); Guy Dassa, Bellevue, WA (US); Jody Biggs, Bellevue, WA (US); Christopher A. Meek, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/032,695

(22) Filed: Feb. 18, 2008

(51) Int. Cl. G06Q 30/00; G06Q 10/00

(52) U.S. Cl. 705/10; 705/7; 705/14

(57) ABSTRACT

A user utility function is implemented in allocating advertisement space to one or more potential advertisers. The user utility function allows advertisement space to be allocated based upon, among other things, the expected utility or usefulness that a proposed advertisement will have to a user. The user utility function, for example, compares proposed advertisements to historical user actions to generate respective user utility values for advertisements (e.g., based upon user responses to advertisements for particular types of product, responses to advertisements from particular types of sellers, etc.). The user utility values can then be applied to bids submitted by advertisers for advertisement space for particular advertisements to obtain modified bids. The modified bids thus reflect, among other things, the expected utility of an advertisement to a user, and thus allow an advertisement host to allocate advertisement space accordingly.

### BACKGROUND

Allocation and pricing of online advertisements is commonly accomplished through the use of an auction. For example, search advertisements are sold in this manner by many search engine companies. This is true for most advertisements (e.g., including those that are not search related). Generally, a cost-per-click (CPC) bid indicates the maximum amount an advertiser will pay a search engine if a user submits a query that contains keywords and subsequently clicks on the advertiser's advertisement. Bids can be converted into per-impression bids prior to being considered by the auction by multiplying a CPC bid by the click-through rate of the advertisement.

This method of advertisement pricing does not, however, account for advertisement quality. Thus, advertisements which may at first appear relevant to a particular query, but after clicking through ends up being irrelevant to the user's search or which may be objectionable to the user can be shown, potentially resulting in a user having a less satisfying experience and/or switching search engines.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A user utility function is implemented in allocating advertisement space to one or more potential advertisers. The user utility function allows advertisement space to be allocated based upon, among other things, the expected utility or usefulness that a proposed advertisement will have to a user. The user utility function, for example, compares proposed advertisements to historical user actions to generate respective user utility values for advertisements (e.g., based upon user responses to advertisements for particular types of product, responses to advertisements from particular types of sellers, etc.). The user utility values can then be applied to bids submitted by advertisers for advertisement space for particular advertisements to obtain modified bids. The modified bids thus reflect, among other things, the expected utility of an advertisement to a user, and thus allow an advertisement host to allocate advertisement space accordingly.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of using a user utility function to aid in allocating advertising space.

FIG. 2 is a component block diagram illustrating an exemplary system for allocating on-line advertisement space offered by an advertisement host for advertisements based upon bids submitted by one or more advertisers for the respective advertisements.

FIG. 3 is a chart illustrating one aspect of an exemplary user utility function.

FIG. 4 is a chart illustrating another aspect of an exemplary user utility function.

FIG. 5 is an illustration of an application of an exemplary method of using a user utility function to an exemplary set of advertisement bids.

FIG. 6 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Internet advertisements are often sold using an auction, where advertisers submit bids comprising amounts they are willing to pay advertisement hosts for allocated advertisement space, submitted during a designated bid period. Bids represent an amount the advertiser is willing to pay per a pre-agreed upon action occurring, for example. This action might comprise their ad being displayed, clicked on, or a sale being conducted to a user after they clicked on the ad, for example. Advertisement hosts then typically choose the bids that are predicted to generate the most revenue. It will be appreciated that the term advertisement hosts as used herein is meant to include any entity that offers advertisement space, including publishers, for example. Currently, major Internet (hosting) companies allocate advertisement space by this auction method. By way of example, in a search-based advertisement auction, advertisers submit bids associated with search keywords. In one example, each advertiser may submit bids based on cost-per-click (CPC), per impression, per conversion, a percentage of revenue share, or a combination of these bases, although most major search engine (as well as other) companies currently only accept CPC bids. CPC bids indicate the amount an advertiser is willing to the advertisement host when a user enters a query containing chosen keywords and subsequently clicks on the advertiser's advertisement. CPC bids may then be converted into per-impresssion impression bids, for example, by combining the CPC bid with a click-through rate of the advertisement. The per-impression bid is considered to be an expectation, as only those impressions that result in clicks by a user are counted towards an advertisement hosts' revenue.

Click-through rates of an advertisement reflect some degree of quality of the advertisement, but the users do not otherwise participate in the auction process. Without more direct participation by the user, often misleading, irrelevant or objectionable advertisements can be shown to the user. These types of advertisements may be useless and/or harmful to a search-based advertisement host. Users, finding these types of ads, are not likely to click-through and, if clicked on and found to be misleading, may decide to switch to another content provider (e.g., search company).

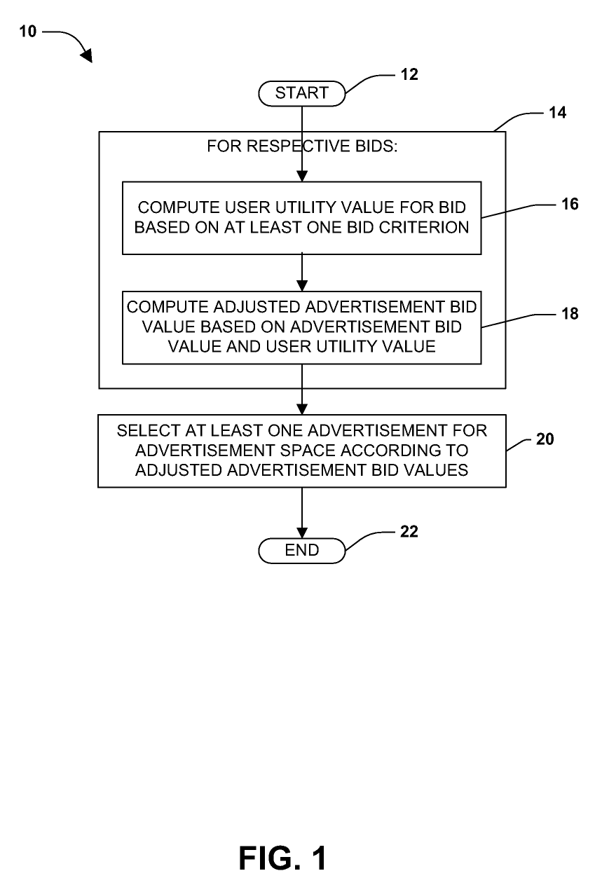

One method for determining relevant advertisements bids, which translates into predicted revenue is detailed in the following description. FIG. 1 illustrates a flowchart diagram of an exemplary method 10 by which an Internet user's experience with an online advertisement environment may be used to measure the relevance of an advertisement bid and translated into a bid value. The exemplary method 10 begins at 12, and involves processing 14 respective bids for the advertisement space. The processing 14 involves computing 16 a user utility value for the bid based on at least one bid criterion, and computing 18 an adjusted advertisement bid value based on the advertisement bid value and the user utility value for the bid. It will be appreciated that bid criterion may comprise, among other things, one or more of the type of advertisement, the content of the advertisement, content of the advertising host page, the content of the advertisement landing page (e.g., the type of page upon which the advertisement is displayed, or rather the content of such page, including other advertisements displayed thereon), the product or service represented by the advertisement, and the advertiser, for example. The exemplary method 10 also involves selecting 20 at least one advertisement for the advertisement space according to the adjusted advertisement bid values. It will be appreciated that while at least one advertisement is said to be selected at 20, method 10 also contemplates selecting no advertisements as well, as that may be better for long term revenue. Having achieved the selection of the advertisements for the advertisement space according to the bid value and the user utility of each advertisement, the exemplary method 10 ends at 22.

In one example for developing modified bid values by applying a user utility function, the user utility function comprises a set of variables <g, b, s>, which, when combined, produce a user utility value based on the user's experience in related Internet advertisement environments. The user utility value may fall within a range of positive or negative values. As used herein, “related Internet advertisement environments” comprises those advertisement environments associated with an advertisement bidder or advertisement bidder's product/services, or similar bidders or products/services. The user utility function produces a user utility value based on the variables <g, b, s> relating to user experiences with related Internet advertisement environments. For example, g represents user experiences comprising good user experiences with which the user utility value is positively proportional, b represents user experiences comprising bad user experiences with which the user utility value is inversely proportional, and s represents user experiences comprising scanned user experiences with which the user utility value is inversely proportional. In another example, g, b, and s can respectively represent counts of good, bad and scanned user experiences. A good user experience can include an experience in which the user interaction with a related Internet advertisement environment comprises an acceptance of a related advertisement, such as where a user transaction (e.g., purchase an item offered for sale through the advertisement) follows the user clicking on the related advertisement. A bad user experience can include a user interaction with a related Internet advertisement environment in which a related advertisement is not accepted, such as, where the advertisement is clicked on but no user transaction follows. A bad user experience can also include, for example, a situation where a user ends up interacting with an unrelated advertisement (e.g., a competitor's advertisement) rather than the particular advertisement at issue. That is, whereas a good user experience can be thought of as one that culminates in a desired transaction, a bad user experience can be thought of as one that does not culminate in a desired transaction. That being said, these are merely examples, and a good user experience may not necessarily culminate in a transaction in a traditional sense. For example, a good user experience may merely comprise the user reading information on a web page (e.g., views posted by a politically party). In this example, the user's act of reading and digesting the information could be regarded as a “transaction”. A scanned user experience can include a “skipped” or “unclicked” advertisement in which the user experience comprises absence of a user interaction with the related Internet advertisement environment. Having yielded a user utility value, that value can be combined with the advertiser's bid value to obtain a modified bid value, and aid in choosing a bid based on these modified bid values.

When at least one advertisement is selected for an advertisement space, user interactions with the advertisement may be monitored to generate historical user experience data, related to the placement of the advertisement, for example, which may be used, e.g., to support the selection of advertisements for a subsequent advertisement space. For example, when a selected advertisement is rendered (e.g., in a web page) for a user, the user interaction with the advertisement may be monitored, and may be recorded as a historical user experience with the selected advertisement. If a user interacts with the advertisement in a manner that results in a transaction, for example, the user experience may be recorded as a good user experience; if the user interacts with the advertisement in a manner that does not result in a transaction or the user clicks on an advertisement that leads to an irrelevant page, the user experience may be recorded as a bad experience; and if the user does not interact with the advertisement, the user experience may be recorded as a skipped user experience. Recording the user interactions may therefore inform the allocation of an advertisement space from among a set of advertisements according not only to the advertisement bid values, but also to the user experiences that are likely to occur with respect to respective advertisements.

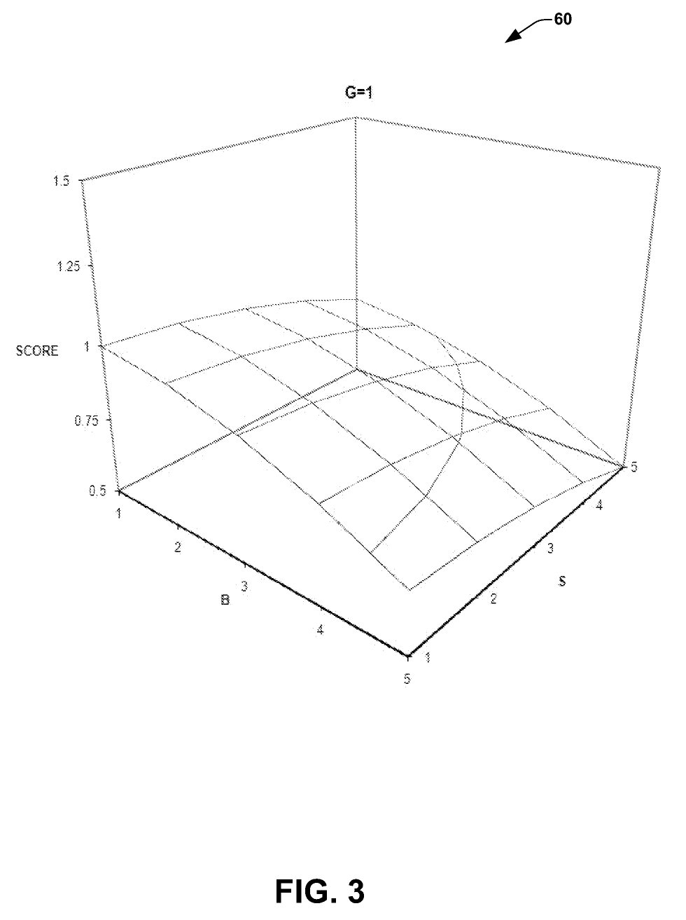

In FIG. 3 there is shown a graphical illustration 60 of an exemplary matrix for one possible formulation of the user utility function in accordance with an embodiment of the method, wherein for the function <g, b, s>, g is equal to 1 and the output of the function comprises various points on the plane in the illustration. As can be seen, as values for b and s increase (e.g., as the number of bad and scanned user experiences increases), the score determined by the function decreases. Similarly, a positively proportional value increases the score and thus, the adjusted bid value, while an inversely proportional value decreases the score which decreases the adjusted bid value.

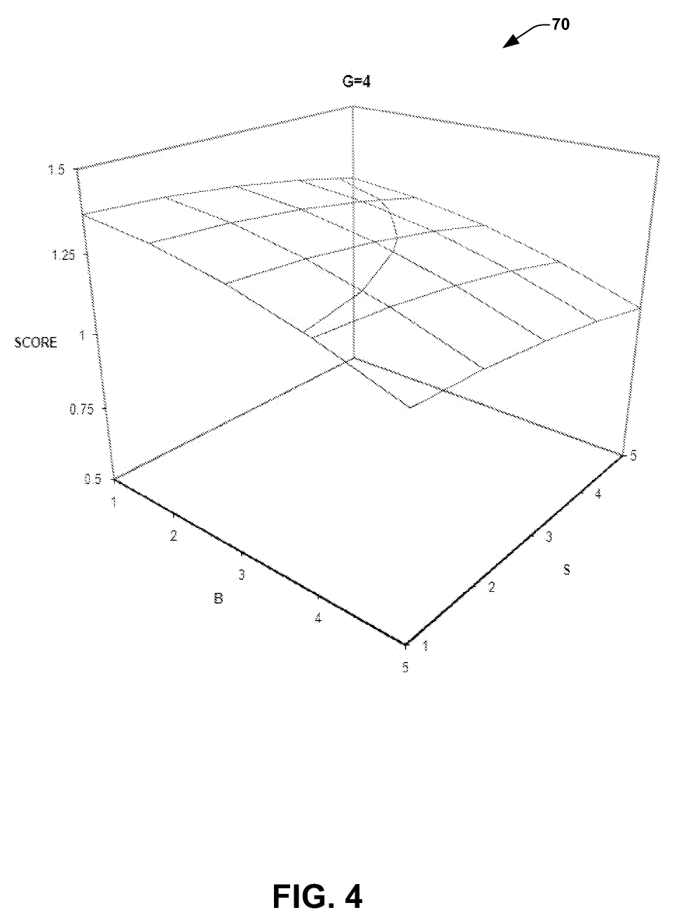

In FIG. 4 there is shown a further graphical illustration 70 of an exemplary matrix for an additional formulation of the user utility function in accordance with an embodiment of the method where g increases. In FIG. 4, g of the function <g, b, s> is equal to 4. As g increases, the plane rises and the curve of the plane decreases. Conversely, as the number of bad user experiences increases, the curve increases. Thus, there is no linear correlation between the score and the user's experiences and there may not be a 1:1 linear decrease.

Many content providers, such as major search engines on the Internet, for example, currently use a “generalized second price” (GSP) auction to rank advertisers bids and determine their per-click prices. The GSP auction ranks advertisement bids based on the expected revenue those advertisements may generate for the advertisement host if the host charged the advertisers the value of their bids for each click. The actual price charged to each advertiser is typically less than this, and is set as the minimum bid the advertiser would need to submit in order to retain his current position in the ranked list. However, this system ignores the potential affect of advertisements on users' search environment experience. If a user's search environment experience is negative they may stop clicking, or click less, on advertisements, leading to a loss in revenue for the advertisement host. Current bid ranking systems are based on click-through rates (CTR). Those advertisements with higher CTR will typically rank higher, and the advertisers will typically pay less for these advertisements. Therefore, advertisers have an incentive to create advertisements that lead to higher CTR, which may encourage deceptive practices to draw more user clicks. Advertisements with a combination of high CTR and low relevance may be considered to be “bad advertisements” for an advertisement host.

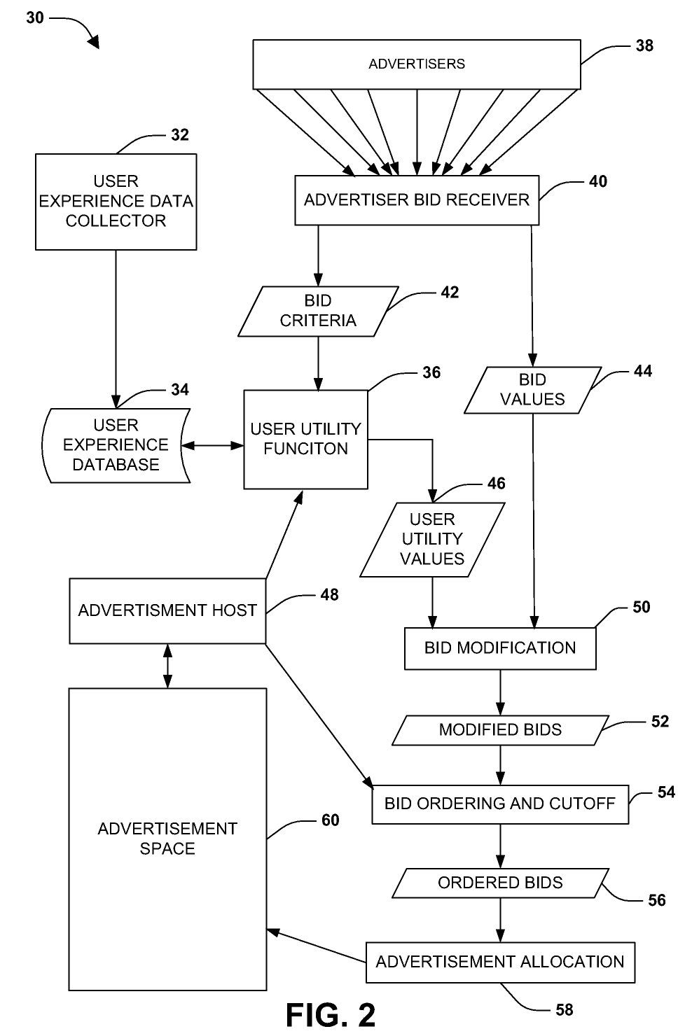

FIG. 2 illustrates a component block diagram of an exemplary system 30 by which an Internet user's experience with an online advertisement environment may be used to measure the relevance of an advertisement bid. The exemplary system 30 involves a component 32 that collects user experience data from Internet advertising environments, and stores the information for analysis in a user experience database component 34. When advertisers 38 submit advertisement bids to an advertiser bid receiver component 40 for a particular advertisement space 60 associated with an advertisement host 48, the bids are broken into two components by the advertiser bid receiver component 40: the bid criteria data 42, and the bid values data 44. The bid criteria data 42 is received by the user utility function 36, which calls to the user experience database 34 for related information based on the received bid criteria 42. The user utility function 36 generates user utility values 46 based on the related user experience data received from the user experience database 34 and advertisement host preferences received from an advertisement host 48. The resulting user utility values 46 are sent to a bid modification system 50, which combines the user utility value 46 with the bid values 44 received from the advertiser bid receiver component 40. The resulting modified bids 52 are sent to a bid ordering and cutoff system 54, which combines the modified bids 52 with advertisement host 48 preferences to generate a preferential ordering of the bids, possibly including a list of bids that may be cut off from advertisement space allocation. The ordered bids 56 are sent to an advertisement allocations component 58, which then allocates bids to advertising space 60.

In one example for generating relevant advertisement bid value rankings, an advertisement host may want to consider long-term value of a particular advertisement. The long-term value may account for, not only expected short-term revenue, but also retention of clientele and meeting expectations of click-through rates (CTRs). Therefore, the host may want to consider some combination of the user utility and the expected revenue of an advertisement, when determining long-term value of a respective advertisement. The user utility is discussed above, and the expected revenue of an advertisement can be some combination of the bid value and the CTR of the respective advertisement. The long-term advertisement value can be illustrated by the following exemplary expression: v=(u,r); where v is the advertisement's long-term value to the advertisement host, u is the user utility, and r is the expected revenue of the advertisement. For example, while sacrificing a portion of the short-term revenue for user utility, the advertisement host may increase the advertisement's long-term value. In this example, the advertisement host can therefore combine the user utility with the expected revenue, for respective advertisements, to generate a long-term value used to rank the advertisements.

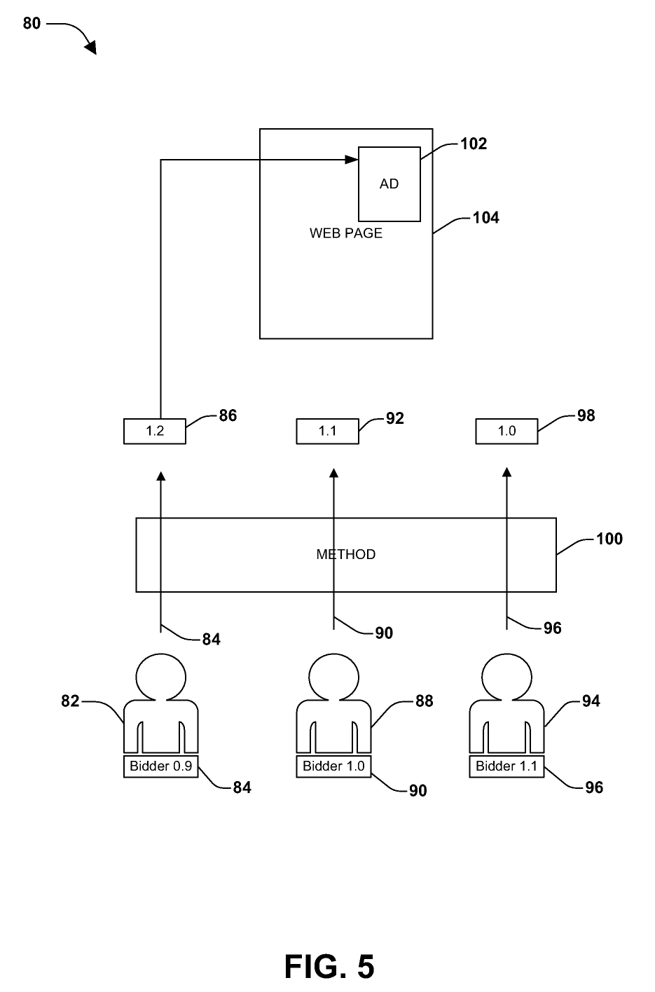

FIG. 5 illustrates an exemplary component block diagram wherein a bid is modified and selected from among a set of bids. Advertisement bidders 82, 88, and 94, each submit bids having a bid value 84, 90, and 96 associated therewith for an advertisement. Bids 84, 90, and 96 represent varying dollar amounts for which a bidder is prepared pay for the advertisement space 102. Bids 84, 90, and 96 proceed through a method for modifying advertisement bids in an advertisement auction, such as the method 100 described with regard to FIG. 1, for example, to produce modified bid values 86, 92, and 98 based on a user utility function. The bid having the highest adjusted bid value, for example, 86, is then accepted and bidder 82 is awarded the advertisement space 102 on the search or other type of web page 104.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

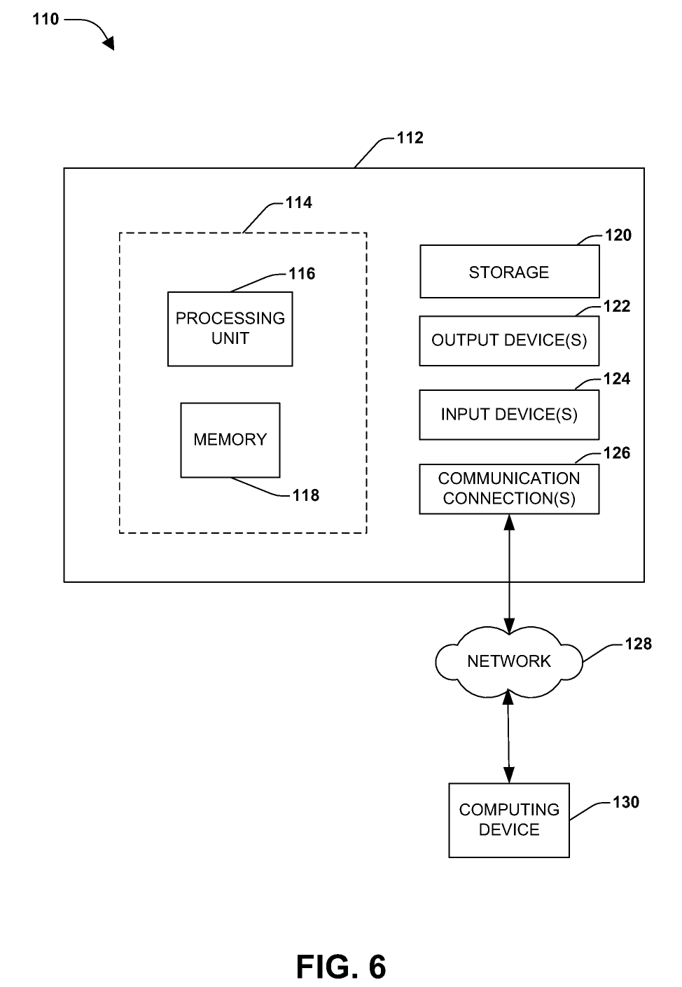

FIG. 6 and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 6 illustrates an example of a system 110 comprising a computing device 112 configured to implement one or more embodiments provided herein. In one configuration, computing device 112 includes at least one processing unit 116 and memory 118. Depending on the exact configuration and type of computing device, memory 118 may be volatile (such as RAM, for example), non-volatile (such as ROM, flash memory, etc., for example) or some combination of the two. This configuration is illustrated in FIG. 6 by dashed line 114.

In other embodiments, device 112 may include additional features and/or functionality. For example, device 112 may also include additional storage (e.g., removable and/or non-removable) including, but not limited to, magnetic storage, optical storage, and the like. Such additional storage is illustrated in FIG. 6 by storage 120. In one embodiment, computer readable instructions to implement one or more embodiments provided herein may be in storage 120. Storage 120 may also store other computer readable instructions to implement an operating system, an application program, and the like. Computer readable instructions may be loaded in memory 118 for execution by processing unit 116, for example.

The term “computer readable media” as used herein includes computer storage media. Computer storage media includes volatile and nonvolatile, removable and non-removable media implemented in any method or technology for storage of information such as computer readable instructions or other data. Memory 118 and storage 120 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 112. Any such computer storage media may be part of device 112.

Device 112 may also include communication connection(s) 126 that allows device 112 to communicate with other devices. Communication connection(s) 126 may include, but is not limited to, a modem, a Network Interface Card (NIC), an integrated network interface, a radio frequency transmitter/receiver, an infrared port, a USB connection, or other interfaces for connecting computing device 112 to other computing devices. Communication connection(s) 126 may include a wired connection or a wireless connection. Communication connection(s) 126 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 112 may include input device(s) 124 such as keyboard, mouse, pen, voice input device, touch input device, infrared cameras, video input devices, and/or any other input device. Output device(s) 122 such as one or more displays, speakers, printers, and/or any other output device may also be included in device 112. Input device(s) 124 and output device(s) 122 may be connected to device 112 via a wired connection, wireless connection, or any combination thereof. In one embodiment, an input device or an output device from another computing device may be used as input device(s) 124 or output device(s) 122 for computing device 112.

Components of computing device 112 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 112 may be interconnected by a network. For example, memory 118 may be comprised of multiple physical memory units located in different physical locations interconnected by a network.

Those skilled in the art will realize that storage devices utilized to store computer readable instructions may be distributed across a network. For example, a computing device 130 accessible via network 128 may store computer readable instructions to implement one or more embodiments provided herein. Computing device 112 may access computing device 130 and download a part or all of the computer readable instructions for execution. Alternatively, computing device 112 may download pieces of the computer readable instructions, as needed, or some instructions may be executed at computing device 112 and some at computing device 130.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of selecting at least one advertisement for an advertisement space offered by an advertisement host among at least one advertisement bid comprising an advertiser, an advertisement, and an advertisement bid value, the method comprising:
for respective bids:
computing a user utility value for the bid based on at least one bid criterion, and
computing an adjusted advertisement bid value based on the advertisement bid value and the user utility value; and
selecting zero or more advertisements for the advertisement space according to the adjusted advertisement bid values.

2. The method of claim 1, comprising:
ordering the bids in the advertisement space according to the adjusted advertisement bid values.

3. The method of claim 2, comprising:
applying at least one cutoff criterion to the ordering of the bids to exclude zero or more advertisements from the advertisement space.

4. The method of claim 1, the at least one bid criterion including historical user experiences with bid related criteria.

5. The method of claim 4, the historical user experiences comprising historical user experiences related to a prior placement of the advertisement.

6. The method of claim 1, the at least one bid criterion comprising at least one of:
type of the advertisement;
content of the advertisement;
content of the advertising host page;
content of the advertisement landing page;
product or service represented by the advertisement; and
the advertiser.

7. The method of claim 1, the user utility function related to at least one advertisement host preference.

8. The method of claim 1, the user utility function related to historical user experiences to the at least one bid related criterion.

9. The method of claim 1, the user utility function related to an advertisement host historical experience with the advertiser.

10. The method of claim 1, the user utility function using variables <g, b, s>, wherein g represents good user experiences with bid related criteria, b represents bad user experiences with bid related criteria, and s represents skipped user experiences with bid related criteria.

11. The method of claim 10:
a good user experience comprising user interaction with a related advertisement culminating in a desired transaction;
a bad user experience comprising user interaction with a related advertisement not culminating in a desired transaction; and
a scanned user experience comprising an absence of user interaction with a related advertisement.

12. The method of claim 8, comprising:
refreshing user experience with bid related criteria.

13. The method of claim 1, the user utility function comprising a three-dimensional matrix relating good user experiences, bad user experiences, and skipped user experiences to a user utility value.

14. The method of claim 1, comprising:
allocating advertisement space when one or more adjusted advertisement bid value meets at least one preset criterion.

15. The method of claim 1, the advertisement bids received during a designated bid period.

16. The method of claim 1, comprising:
monitoring user interactions with respective renderings of the selected advertisement, and
recording the user interactions as a historical user experience with the selected advertisement.

17. The method of claim 16, respective user interactions recorded as a good user experience, a bad user experience, and a skipped user experience.

18. A system for allocating on-line advertisement space offered by an advertisement host for advertisements based upon bids submitted by one or more advertisers for the respective advertisements, the system comprising:
a user utility function component configured to compute a user utility value for a bid based on at least one bid criterion;
a bid modification component configured to compute an adjusted advertisement bid value based on the advertisement bid value and the user utility value; and
an advertisement space allocation component configured to select an advertisement for the advertisement space according to the adjusted advertisement bid values.

19. The system of claim 18, the system comprising:
a user experience database representing at least one historical user experience with at least one advertisement;
and the user utility function component configured to compute the user utility value based on at least one historical experience related to the advertisement.

20. A method of selecting an advertisement for an advertisement space offered by an advertisement host among at least one advertisement bid received during a designated bid period and comprising an advertiser, an advertisement, and an advertisement bid value, the method comprising:
for respective bids:
computing a user utility value for the bid using variables <g, b, s>, wherein:
g represents good user experiences with bid related criteria comprising user interactions with a related advertisement culminating in desired transactions;
b represents bad user experiences with bid related criteria comprising user interactions with a related advertisement not culminating in desired transactions; and
s represents skipped user experiences with bid related criteria comprising an absence of user interactions with a related advertisement;
and the at least one bid criterion comprising at least one of:
at least one advertisement host preference,
type of the advertisement,
content of the advertisement,
content of the advertising host page
content of the advertisement landing page,
product or service represented by the advertisement,
the advertiser, and
historical user experiences related to prior placement of the advertisement; and
computing an adjusted advertisement bid value based on the advertisement bid value and the user utility value;
selecting zero or more advertisements for the advertisement space according to the adjusted advertisement bid values;
applying at least one cutoff criterion to the ordering of the bids to exclude zero or more advertisements from the advertisement space; and
ordering the bids in the advertisement space according to the adjusted advertisement bid values;
monitoring user interactions with respective renderings of the selected advertisement; and
recording the user interactions as a historical user experience with the selected advertisement, respective user interactions recorded as a good user experience, a bad user experience, and a skipped user experience.
